(19) United States
(12) Patent Application Publication
(10) Pub. No.: US 2025/0303679 A1
(43) Pub. Date: Oct. 2, 2025

(54) LAMINATE

(71) Applicant: YUPO CORPORATION, Tokyo (JP)

(72) Inventor: Takuya IKARASHI, Ibaraki (JP)

(73) Assignee: YUPO CORPORATION, Tokyo (JP)

(21) Appl. No.: 19/091,968

(22) Filed: Mar. 27, 2025

(30) Foreign Application Priority Data
Mar. 29, 2024 (JP) 2024-056450

(51) Int. Cl. B32B 27/10; B32B 7/027; B32B 27/20; B32B 27/30; B32B 27/32

(52) U.S. Cl. CPC B32B 27/10; B32B 7/027; B32B 27/20; B32B 27/308; B32B 27/32; B32B 2250/246; B32B 2264/104; B32B 2270/00; B32B 2307/30; B32B 2307/31; B32B 2307/718; B32B 2307/7376; B32B 2307/748; B32B 2519/00

(57) ABSTRACT

Provided is a laminate that achieves favorable adhesive strength to an adherend and physically favorable removability. A laminate comprising a heat sealing layer and an underlayer, wherein a solid content per unit area of the heat sealing layer is 0.05 to 1.5 g/m², the heat sealing layer comprises a thermoplastic resin (A) having a melting point of Tm(A), the underlayer comprises a thermoplastic resin (B), the thermoplastic resin (B) has a melting point Tm(B) of (Tm(A)+10° C.) or higher and lower than (Tm(A)+60° C.), a content of a thermoplastic resin having a melting point of lower than (Tm(A)+10° C.) in the underlayer is 20% by mass or less, and a content of the thermoplastic resin (B) in the underlayer is 20 to 50% by mass.

### CROSS-REFERENCE TO RELATED APPLICATIONS

This application is based on and claims priority under 35 USC 119 from Japanese Patent Application No. 2024-056450 filed on Mar. 29, 2024, the entire content of which is incorporated herein by reference.

### TECHNICAL FIELD

The present invention relates to a laminate.

### BACKGROUND ART

In general, various contents are housed in resin containers and sold. Thus, labels that describe information explaining the contents may be attached to the resin container.

Accordingly, the labels are usually required to have large adhesive strength to resin containers. On the other hand, the labels are also required to be capable of being easily removed from labeled resin containers after use from the viewpoint of the recycling of resin containers.

In response to this, Patent Literature 1 discloses an in-mold label that achieves label adhesiveness and removability. The in-mold label can be removed from a resin container by dipping in an aqueous sodium hydroxide solution with a high temperature. This exploits the step of dipping a resin container after use in hot water or a hot alkaline aqueous solution for washing the container upon recycling treatment.

### CITATION LIST

### Patent Literature

Patent Literature 1: Japanese Patent Laid-Open No. 2006-168354

### SUMMARY OF INVENTION

### Problems to be Solved by the Invention

However, the timing of removing of labels in the process of recycling resin containers is not limited to the step of dipping a resin container in hot water or a hot alkaline aqueous solution for washing as described above. Examples thereof include the case where consumers themselves peel labels in sorting resin containers, and the case where labels are removed in a resin container granulation step that is carried out before the washing described above.

Accordingly, an object of the present invention is to provide a laminate that achieves favorable adhesive strength to an adherend and physically favorable removability as a laminate suitable for the label.

### Means for Solving the Problems

There is a trade-off relationship between having high adhesive strength to an adherend and being physically able to easily remove a laminate from an adherend. Nonetheless, the present inventor has conducted diligent studies and consequently completed the present invention by finding that in a laminate comprising a heat sealing layer and an underlayer, high adhesive strength and favorable removability can be achieved through the use of a specific thermoplastic resin contained in each layer and a specific solid content per unit area of the heat sealing layer.

Specifically, one aspect of the present embodiment is summarized as follows.

[1] A laminate comprising a heat sealing layer and an underlayer, wherein
a solid content per unit area of the heat sealing layer is 0.05 to 1.5 g/m²,
the heat sealing layer comprises a thermoplastic resin (A) having a melting point of Tm(A),
the underlayer comprises a thermoplastic resin (B),
the thermoplastic resin (B) has a melting point Tm(B) of (Tm(A)+10° C.) or higher and lower than (Tm(A)+60° C.),
a content of a thermoplastic resin having a melting point of lower than (Tm(A)+10° C.) in the underlayer is 20% by mass or less, and
a content of the thermoplastic resin (B) in the underlayer is 20 to 50% by mass.
   [2] The laminate according to [1], wherein
the underlayer further comprises a thermoplastic resin (C), and
the thermoplastic resin (C) has a melting point Tm(C) of (Tm(A)+60° C.) or higher.
   [3] The laminate according to [1] or [2]: wherein the underlayer further comprises a particle.
   [4] The laminate according to any one of [1] to [3], wherein a thickness of the underlayer is 0.5 to 10 μm.
   [5] The laminate according to any one of [1] to [4], wherein a content of the thermoplastic resin (A) in the heat sealing layer is 50% by mass or more.
   [6] The laminate according to [1], wherein a content of the thermoplastic resin (B) in the underlayer is 20 to 50% by mass.
   [7] The laminate according to [2], wherein a content of the thermoplastic resin (C) in the underlayer is 5 to 80% by mass.
   [8] The laminate according to [3], wherein a content of the particle in the underlayer is 5 to 70% by mass. [9] The laminate according to [3], wherein the underlayer is a stretched layer and contain a pore.
   [10] The laminate according to [1], wherein a porosity of the underlayer is 3 to 30%.

### Advantageous Effects of Invention

The laminate according to the present embodiment can achieve favorable adhesive strength to an adherend and physically favorable removability. Hence, the laminate bonded to an adherend with high strength without practical problems can be easily removed by, for example, the manual operation (manual peeling) of consumers or a granulation step for the adherend (e.g., a resin container). Furthermore, heat sealing layer residues can also be suppressed.

### Mode for Carrying Out the Invention

Hereinafter, the mode for carrying out the present invention will be described in detail. However, the description given below is one aspect of the embodiments of the present invention, and the present invention is not limited by these contents. The present invention can be carried out through arbitrary changes or modifications made without departing from the spirit of the present invention.

In the present specification, the term “to” that indicates a numeric range is used in a meaning including numeric values described before and after this term as the lower and upper limit values.

### <<Laminate>>

The laminate according to the present embodiment comprises a heat sealing layer and an underlayer.

A solid content per unit area of the heat sealing layer is 0.05 to 1.5 g/m², and the heat sealing layer comprises a thermoplastic resin (A).

The underlayer comprises 20 to 50% by mass of a thermoplastic resin (B) having a melting point Tm(B) of (Tm(A)+10° C.) or higher and lower than (Tm(A)+60° C.) with respect to a melting point Tm(A) of the thermoplastic resin (A) contained in the heat sealing layer.

A content of a thermoplastic resin having a melting point of lower than (Tm(A)+10° C.) with respect to the melting point Tm(A) of the thermoplastic resin (A), in the underlayer is 20% by mass or less.

Usually, a heat sealing layer needs to have a given thickness for exerting a heat sealing function. However, a thick heat sealing layer facilitates difficult manual peeling or difficult removing in a granulation step. By contrast, the laminate according to the present embodiment can achieve high removability by setting the solid content per unit area of the heat sealing layer to be as thin as 0.05 to 1.5 g/m².

On the other hand, adhesiveness is reduced by adopting this solid content per unit area. Accordingly, the laminate according to the present embodiment comprises a specific thermoplastic resin (B) in the underlayer serving as the foundation of the heat sealing layer.

The thermoplastic resin (B) adopts its melting point Tm(B) within a given range with respect to the melting point Tm(A) of the thermoplastic resin (A) contained in the heat sealing layer, and the content ratio thereof falls within a specific range.

As a result, adhesiveness and removability, which have heretofore been considered difficult to achieve, can be kept in excellent balance. Thus, the present invention has been completed. The laminate according to the present embodiment is likely to prevent the heat sealing layer from remaining on an adherend when the laminate is removed from the adherend. The adherend after removing of the laminate can be recycled with much better purity.

### <Heat Sealing Layer>

The heat sealing layer according to the present embodiment is a layer that exerts the adhesiveness of the laminate to an adherend by heating.

The heat sealing layer according to the present embodiment comprises a thermoplastic resin (A).

The thermoplastic resin (A) is preferably a heat sealing resin.

The thermoplastic resin (A) preferably has a melting point, more preferably a melting point that allows the thermoplastic resin to be melted at a heating temperature in bonding the laminate according to the present embodiment to an adherend, from the viewpoint of adhesiveness to an adherend.

The melting point Tm(A) of the thermoplastic resin (A) is preferably 60 to 120° C. In this context, the melting point Tm(A) is preferably 120° C. or lower, more preferably 110° C. or lower, further preferably 100° C. or lower, from the viewpoint of adhesiveness to an adherend. The melting point Tm(A) is preferably 60° C. or higher, more preferably 80° C. or higher, further preferably 85° C. or higher, from the viewpoint of the prevention of blocking and removability.

Examples of the thermoplastic resin (A) include polyethylene-based resin.

Examples of the polyethylene-based resin include high-density polyethylene, medium-density polyethylene, low-density polyethylene, linear low-density polyethylene, ethylene-α olefin copolymers, ethylene-vinyl acetate copolymers, ethylene-(meth)acrylic acid copolymers, ethylene-(meth)acrylic acid alkyl ester copolymers, and metal salts of ethylene-(meth)acrylic acid copolymers.

In this context, the ethylene-(meth)acrylic acid alkyl ester copolymer preferably has an alkyl group having 1 to 8 carbon atoms. The metal salt of an ethylene-(meth)acrylic acid copolymer is preferably a salt with one or more metals selected from the group consisting of, for example, Zn, Al, Li, K, and Na.

In the present specification, the (meth)acrylic acid means at least one of acrylic acid and methacrylic acid.

The content of the thermoplastic resin (A) in the heat sealing layer according to the present embodiment is preferably 50% by mass or more and may be 50 to 100% by mass or may be 50 to 99% by mass. In this context, the content is preferably 50% by mass or more, more preferably 65% by mass or more, further preferably 80% by mass or more, from the viewpoint of enhancing adhesiveness to an adherend. The content may be 100% by mass, i.e., the heat sealing layer consists of the thermoplastic resin (A). When the heat sealing layer comprises an additional component, the content may be 99% by mass or less, may be 95% by mass or less, or may be 90% by mass or less, from the viewpoint of suitably obtaining an effect brought about by the additional component.

The heat sealing layer according to the present embodiment may further comprise an additional component other than the thermoplastic resin (A).

Examples of the additional component include ethyleneimine polymers and aid components.

The heat sealing layer according to the present embodiment preferably further comprises an ethyleneimine polymer in addition to the thermoplastic resin (A). The heat sealing layer comprising the ethyleneimine polymer can improve the adhesiveness of the heat sealing layer to the underlayer and tends to be able to prevent the heat sealing layer from remaining on an adherend when the laminate is removed from the adherend. The heat sealing layer comprising the ethyleneimine polymer also imparts favorable wettability to the underlayer and tends to be able to achieve more stable adhesive strength.

The content of the ethyleneimine polymer in the heat sealing layer is preferably, for example, 1 to 15% by mass. In this context, the content is preferably 1% by mass or more, more preferably 3% by mass or more, further preferably 5% by mass or more, from the viewpoint of wettability to the underlayer. The content is preferably 15% by mass or less, more preferably 10% by mass or less, further preferably 8% by mass or less, from the viewpoint of adhesiveness to an adherend.

Examples of the aid component according to the present embodiment include antistatic agents, cross-linking promoters, antiblocking agents, pH adjusters, and antifoaming agents.

The content of each aid component in the heat sealing layer is, for example, 0.1 to 10% by mass and may be 0.5 to 5% by mass. The total content of the aid components is, for example, 0.1 to 10% by mass and may be 0.5 to 5% by mass. In this context, the content of each aid component is preferably 0.1% by mass or more, more preferably 0.5% by mass or more, and the total content is preferably 0.1% by mass or more, more preferably 0.5% by mass or more, from the viewpoint of suitably obtaining an effect brought about by the aid. On the other hand, the content of each aid component is preferably 10% by mass or less, more preferably 5% by mass or less, and the total content is preferably 10% by mass or less, more preferably 5% by mass or less, from the viewpoint of suitably obtaining an effect brought about by the additional component.

The heat sealing layer according to the present embodiment may further comprise a resin having no melting point in addition to the thermoplastic resin (A). However, the content of the resin having no melting point in the heat sealing layer is preferably 15% by mass or less, more preferably 10% by mass or less, further preferably 8% by mass or less, from the viewpoint of adhesive strength to an adherend.

The heat sealing layer according to the present embodiment is preferably a coating layer formed by coating from the viewpoint of thin film formation.

The thickness of the heat sealing layer according to the present embodiment can be defined by a solid content (amount of coating) per unit area.

The solid content per unit area of the heat sealing layer according to the present embodiment is 0.05 to 1.5 g/m². In this context, the solid content is 0.05 g/m² or more, preferably 0.07 g/m² or more, more preferably 0.08 g/m² or more, further preferably 0.1 g/m² or more, from the viewpoint of adhesiveness to an adherend. The solid content is 1.5 g/m² or less, preferably 1.0 g/m² or less, more preferably 0.8 g/m² or less, further preferably 0.5 g/m² or less, from the viewpoint of removability.

A conventional heat sealing layer needs to have a thickness beyond a given level for exerting a favorable heat sealing function. However, the laminate according to the present embodiment can ensure favorable adhesiveness to an adherend through the use of a specific thermoplastic resin (B) contained in the underlayer. Therefore, the solid content per unit area of the heat sealing layer can fall within the above range. As a result, even favorable removability can be achieved.

### <Underlayer>

The underlayer according to the present embodiment is a layer serving as the foundation of the heat sealing layer in the laminate and can precisely control the adhesiveness to an adherend and removability of the laminate, together with the heat sealing layer.

The underlayer may be a stretched layer or may be a non-stretched layer. The underlayer may be a single layer or multiple layers.

The underlayer according to the present embodiment comprises a thermoplastic resin (B).

The thermoplastic resin (B) is preferably semi-melted at a heating temperature in bonding the laminate to an adherend. The underlayer comprising such a thermoplastic resin (B) at a specific content moderately decreases the modulus of elasticity of the underlayer at a heating temperature in heat sealing so that favorable removability can be achieved while high adhesiveness to an adherend can be obtained.

The thermoplastic resin (B) according to the present embodiment has a higher melting point Tm(B) than the melting point Tm(A) of the thermoplastic resin (A) contained in the heat sealing layer. Specifically, the melting point Tm(B) of the thermoplastic resin (B) is preferably higher by 10° C. or more and less than 60° C. than the melting point Tm(A) of the thermoplastic resin (A). In other words, the melting point Tm(B) is preferably (Tm(A)+10° C.) or higher and lower than (Tm(A)+60° C.).

In this context, the difference between the melting point Tm(B) of the thermoplastic resin (B) and the melting point Tm(A) of the thermoplastic resin (A) is preferably 10° C. or more, more preferably 20° C. or more, further preferably 30° C. or more, from the viewpoint of removability. The difference between the melting points is preferably less than 60° C., more preferably 58° C. or less, further preferably 56° C. or less, from the viewpoint of adhesiveness to an adherend.

The melting point Tm(B) of the thermoplastic resin (B) according to the present embodiment is not particularly limited as long as the melting point falls within the range mentioned above with respect to the melting point Tm(A) of the thermoplastic resin (A). The melting point Tm(B) differs depending on the type of an adherend and is preferably, for example, 70° C. to 150° C. In this context, the melting point Tm(B) is preferably 150° C. or lower, more preferably 148° C. or lower, further preferably 146° C. or lower, still further preferably 145° C. or lower, from the viewpoint of adhesiveness to an adherend.

On the other hand, the melting point Tm(B) is preferably 70° C. or higher, more preferably 80° C. or higher, further preferably 100° C. or higher, still further preferably 120° C. or higher, particularly preferably 130° C. or higher, from the viewpoint of removability.

Examples of the thermoplastic resin (B) include propylene copolymers that are composed mainly of propylene, are obtained by copolymerization with α-olefin such as ethylene, 1-butene, 1-hexene, 1-heptene, 1-octene, and 4-methyl-1-pentene, and have various stereoregularities, and ethylene polymers such as high-density polyethylene, medium-density polyethylene, and ethylene-α olefin copolymers.

The thermoplastic resin (B) is such a propylene copolymer or an ethylene polymer and thereby enhances the adhesion between the underlayer surface-treated by oxidation and the heat sealing layer. As a result, the heat sealing layer is unlikely to remain on an adherend, and laminate residues are unlikely to remain, when the laminate according to the present embodiment is removed from the adherend.

The content of the thermoplastic resin (B) in the underlayer according to the present embodiment is 20 to 50% by mass. In this context, the content is 20% by mass or more, preferably 25% by mass or more, further preferably 30% by mass or more, from the viewpoint of enhancing adhesiveness to an adherend. The content is 50% by mass or less, preferably 45% by mass or less, further preferably 40% by mass or less, from the viewpoint of suppressing reduction in removability associated with excessive adhesiveness of the laminate to an adherend.

The underlayer according to the present embodiment may further comprise an additional component other than the thermoplastic resin (B).

Examples of the additional component include a thermoplastic resin (C), particles, antioxidants, light stabilizers, dispersants, and lubricants.

The thermoplastic resin (C) is a resin having a melting point Tm(C) higher by 60° C. or more than the melting point Tm(A) of the thermoplastic resin (A), i.e., a thermoplastic resin that satisfies a relationship of Tm(C)≥(Tm(A)+60° C.).

The underlayer according to the present embodiment preferably further comprises the thermoplastic resin (C) in addition to the thermoplastic resin (B) from the viewpoint of suppressing excessive elevation of adhesiveness to an adherend and easily obtaining favorable removability.

The melting point Tm(C) of the thermoplastic resin (C) can be (Tm(A)+60° C.) or higher and is preferably, for example, (Tm(A)+60° C.) or higher and (Tm(A)+100° C.) or lower. In this context, the melting point Tm(C) is (Tm(A)+60° C.) or higher, preferably (Tm(A)+65° C.) or higher, more preferably (Tm(A)+70° C.) or higher, from the viewpoint of removability. The melting point Tm(C) is preferably (Tm(A)+100° C.) or lower, more preferably (Tm(A)+90° C.) or lower, further preferably (Tm(A)+80° C.) or lower, from the viewpoint of adhesive strength to an adherend.

The melting point Tm(C) of the thermoplastic resin (C) according to the present embodiment is not particularly limited as long as the melting point falls within the range mentioned above with respect to the melting point Tm(A) of the thermoplastic resin (A). The melting point Tm(C) differs depending on the type of an adherend and is preferably 120° C. or higher, more preferably 120 to 200° C. In this context, the melting point Tm(C) is preferably 120° C. or higher, more preferably 145° C. or higher, further preferably 155° C. or higher, from the viewpoint of removability. The upper limit is not particularly limited, and the melting point Tm(C) is preferably 200° C. or lower, more preferably 190° C. or lower, further preferably 180° C. or lower, from the viewpoint of adhesive strength to an adherend.

Examples of the thermoplastic resin (C) include polyolefin-based resin, polystyrene-based resin, polyester-based resin, polyamide-based resin, and polycarbonate-based resin. Among them, polyolefin-based resin is preferred, and a propylene homopolymer is more preferred.

When the laminate according to the present embodiment further has a substrate layer mentioned later, the thermoplastic resin (C) is preferably the same type of resin as that of a thermoplastic resin for use in the substrate layer from the viewpoint of interlayer strength to the substrate layer. However, it is not required that the thermoplastic resin (C) and the thermoplastic resin for use in the substrate layer should be completely the same resins. Any aspect in which the thermoplastic resin (C) and the thermoplastic resin for use in the substrate layer are different types of resins is not excluded from the present invention.

When the underlayer according to the present embodiment comprises the thermoplastic resin (C), the content of the thermoplastic resin (C) in the underlayer is preferably 5 to 80% by mass. In this context, the content is preferably 5% by mass or more, more preferably 10% by mass or more, further preferably 25% by mass or more, from the viewpoint of removability. The content is preferably 80% by mass or less, more preferably 70% by mass or more, further preferably 60% by mass or less, from the viewpoint of adhesiveness to an adherend. The underlayer may not comprise the thermoplastic resin (C).

The underlayer according to the present embodiment preferably further comprises a particle in addition to the thermoplastic resin (B) from the viewpoint of suppressing excessive elevation of adhesiveness to an adherend and easily obtaining favorable removability. The underlayer, when being a stretched layer, more preferably contains a particle. In this case, a pore originating from the particle can be formed in the underlayer. In other words, the underlayer can contain a pore originating from the particle.

The particle may employ any of inorganic and organic particles.

Examples of the inorganic particle include heavy calcium carbonate, light calcium carbonate, baked clay, silica, diatomaceous earth, talc, titanium oxide, barium sulfate, and alumina.

Examples of the organic particle include polyethylene terephthalate, polybutylene terephthalate, polycarbonate, nylon-6, nylon-6,6, nylon-6, cyclic olefin, polystyrene, and polymethacrylate.

When the underlayer according to the present embodiment comprises the particle, the content of the particle in the underlayer is preferably 5 to 70% by mass. In this context, the content is preferably 5% by mass or more, more preferably 20% by mass or more, further preferably 30% by mass or more, from the viewpoint of removability. The content is preferably 70% by mass or less, more preferably 60% by mass or less, further preferably 50% by mass or less, from the viewpoint of adhesiveness to an adherend. The underlayer may not comprise the particle.

One type of particle may be used, or two or more types of particles may be used. The inorganic particle and the organic particle may be used in combination.

When two or more types of particles are contained, the total content thereof preferably falls within the above range.

The underlayer according to the present embodiment preferably comprises the thermoplastic resin (C) and the particle together in addition to the thermoplastic resin (B).

In this case, the total content of the thermoplastic resin (C) and the particle in the underlayer is preferably 40 to 80% by mass. In this context, the total content is preferably 40% by mass or more, more preferably 50% by mass or more, further preferably 60% by mass or more, from the viewpoint of removability. The total content is preferably 80% by mass or less, more preferably 75% by mass or less, further preferably 70% by mass or less, from the viewpoint of the adhesiveness of the laminate to an adherend.

On the other hand, the content of a thermoplastic resin having a melting point of lower than (Tm(A)+10° C.) with respect to the melting point Tm(A) of the thermoplastic resin (A), in the underlayer according to the present embodiment is 20% by mass or less. Too large a content of the thermoplastic resin having such a melting point in the underlayer might reduce the removability of the laminate. Hence, the content of the thermoplastic resin in the underlayer is 20% by mass or less, preferably 10% by mass or less, more preferably 8% by mass or less, further preferably 6% by mass or less. The content of the thermoplastic resin may be 0% by mass. In other words, it is also preferred that the underlayer should not comprise the thermoplastic resin.

The content of the thermoplastic resin (B) based on the total content of the thermoplastic resin having a melting point of lower than (Tm(A)+10° C.) with respect to the melting point Tm(A) of the thermoplastic resin (A), and the thermoplastic resin (B) in the underlayer according to the present embodiment is preferably 50 to 100% by mass. In this context, the content is preferably 50% by mass or more, more preferably 65% by mass or more, further preferably 80% by mass or more, still further preferably 95% by mass or more, from the viewpoint of suppressing reduction in removability of the laminate caused by an increased content ratio of the thermoplastic resin having the melting point as described above. The upper limit of the content is not particularly limited and may be 100% by mass. In other words, it is also preferred that the underlayer should not comprise the thermoplastic resin.

The underlayer according to the present embodiment may further comprise, if necessary, an additive as an additional component. Examples of the additive include heat stabilizers, antioxidants, ultraviolet stabilizers, dispersants, and lubricants. These various agents can employ conventionally known ones.

The content of the additive in the underlayer according to the present embodiment may be, for example, 0.1 to 10% by mass. In this context, the content may be, for example, 0.1% by mass or more or may be 0.5% by mass or more and may be 10% by mass or less or may be 5% by mass or less. When two or more types of additives are contained, the total content thereof preferably falls within the above range.

The underlayer according to the present embodiment is preferably substantially free of a resin having no melting point. In this context, the phrase “substantially free” means that the content in the underlayer is 10% by mass or less. The content of the resin having no melting point in the underlayer may be 5% by mass or less, may be 1% by mass or less, or may be 0% by mass. The underlayer substantially free of the resin having no melting point tends to be able to more favorably maintain the adhesiveness between the individual layers.

The thickness of the underlayer according to the present embodiment is preferably 0.5 to 10 μm. In this context, the thickness is preferably 0.5 μm or larger, more preferably 1 μm or larger, further preferably 2.5 μm or larger, from the viewpoint of adhesiveness to an adherend. The thickness is preferably 10 μm or smaller, more preferably 5 μm or smaller, further preferably 3.5 μm or smaller, from the viewpoint of removability.

The porosity of the underlayer according to the present embodiment is preferably 30% or less. In this context, the porosity is preferably 0% or more, more preferably 3% or more, further preferably 5% or more, from the viewpoint of obtaining opacity and from the viewpoint of efficiently obtaining favorable adhesiveness to an adherend using a limited quantity of heat of a parison in in-mold molding. The porosity is preferably 30% or less, more preferably 20% or less, further preferably 15% or less, still further preferably 10% or less, from the viewpoint of preventing the heat sealing layer from remaining on an adherend.

In the present specification, the porosity is a value calculated according to the following expression (1).

$$Porosity ( \% ) = \{ ( {ρ}_{0} - ρ ) / {ρ}_{0} \} \times 100 \qquad ( 1 )$$

wherein ρ₀ represents a true density, and ρ represents a density.

In this context, the true density of each layer is determined by an underwater displacement method from the press sheet of the thermoplastic resin used on the basis of Method A of JIS K 7112:1999 “Plastics—Methods of determining the density and relative density of non-cellular plastics”.

The density is determined by the following method: on the basis of JIS P 8124:2011 “Paper and board—Determination of grammage”, a grammage is determined by dividing a mass determined by the weighing of a laminate punched into a size of 100 mm×100 mm by an area. Subsequently, the obtained grammage is divided by the thickness of the laminate, and the resulting value is regarded as the density.

### <Substrate Layer>

The laminate according to the present embodiment may further comprise an additional layer in addition to the heat sealing layer and the underlayer. Examples of the additional layer include substrate layers.

The substrate layer is a layer that supports the heat sealing layer and the underlayer and imparts, to the laminate, stiffness (rigidity) that permits handling in printing or processing.

When the laminate according to the present embodiment comprises the substrate layer, the laminate preferably comprises the heat sealing layer, the underlayer, and the substrate layer in this order.

The substrate layer according to the present embodiment may be a stretched layer or may be a non-stretched layer. The substrate layer may be a single layer or multiple layers.

The substrate layer according to the present embodiment preferably comprises a thermoplastic resin.

The thermoplastic resin for use in the substrate layer is preferably neither melted nor softened at a heating temperature in bonding the laminate to an adherend.

The thermoplastic resin preferably has a melting point Tm higher by 60° C. or more than the melting point Tm(A) of the thermoplastic resin (A). In other words, the melting point Tm of the thermoplastic resin contained in the substrate layer is preferably (Tm(A)+60° C.) or higher, more preferably (Tm(A)+60° C.) or higher and (Tm(A)+120° C.) or lower. In this context, the melting point Tm is preferably (Tm(A)+60° C.) or higher from the viewpoint of removability. The melting point Tm is preferably (Tm(A)+120° C.) or lower, more preferably (Tm(A)+110° C.) or lower, further preferably (Tm(A)+100° C.) or lower, from the viewpoint of heat resistance.

The melting point Tm of the thermoplastic resin is not particularly limited as long as the melting point falls within the range mentioned above with respect to the melting point Tm(A) of the thermoplastic resin (A). The melting point Tm is preferably, for example, 120° C. or higher, more preferably 120 to 200° C. The melting point Tm is preferably 120° C. or higher, more preferably 145° C. or higher, further preferably 155° C. or higher. The upper limit is not particularly limited, and the melting point Tm is preferably 200° C. or lower, more preferably 190° C. or lower, further preferably 180° C. or lower, from the viewpoint of moldability.

Examples of the thermoplastic resin used in the present embodiment include: polyolefin-based resin such as polyethylene-based resin and polypropylene-based resin; polystyrene-based resin; polyester-based resin; polyamide-based resin; and polycarbonate-based resin. Only one of these thermoplastic resins may be used, or two or more types thereof may be used as a mixture.

The thermoplastic resin is more preferably polyolefin-based resin from the viewpoint of processability. When the underlayer comprises the thermoplastic resin (C), the thermoplastic resin is preferably the same type of resin as that of the thermoplastic resin (C) from the viewpoint of interlayer strength to the underlayer.

Examples of the polyolefin-based resin include homopolymers constituted by olefin monomers such as ethylene, propylene, butylene, pentene, hexene, octene, butadiene, isoprene, chloroprene, methyl-1-pentene, or cyclic olefin, and copolymers constituted by two or more types of these olefin monomers.

The polyolefin-based resin is further preferably polyethylene-based resin or polypropylene-based resin.

The content of the thermoplastic resin in the substrate layer according to the present embodiment is preferably 35 to 90% by mass. In this context, the content is preferably 35% by mass or more, more preferably 40% by mass or more, from the viewpoint of the imparting of stiffness. The content may be 90% by mass or less or may be 70% by mass or less, from the viewpoint of obtaining an effect of an additional component. In the case of mixing two or more thermoplastic resins for use, the total content thereof preferably falls within the above range.

The substrate layer according to the present embodiment may further comprise an additional component. Examples of the additional component include particles and additives.

The substrate layer according to the present embodiment preferably further comprises a particle in addition to the thermoplastic resin. The substrate layer, when being a stretched layer, more preferably comprises a particle. The substrate layer thereby has a pore originating from the particle. As a result, the heat insulating properties of the laminate are increased and are unlikely to allow the quantity of heat of a parison to escape. Therefore, adhesive strength to an adherend can be improved. The texture of paper may be imparted to the laminate by elevating the degree of whiteness and opacity.

On the other hand, the substrate layer according to the present embodiment may have neither a pore nor a particle from the viewpoint of removability, transparency, and the like.

When the substrate layer according to the present embodiment comprises the particle, the particle may employ any of inorganic and organic particles.

Examples of the inorganic particle include heavy calcium carbonate, light calcium carbonate, baked clay, silica, diatomaceous earth, talc, titanium oxide, barium sulfate, and alumina.

Examples of the organic particle include polyethylene terephthalate, polybutylene terephthalate, polycarbonate, nylon-6, nylon-6,6, nylon-6, cyclic olefin, polystyrene, and polymethacrylate.

The content of the particle in the substrate layer according to the present embodiment is preferably 5 to 60% by mass. In this context, the content is preferably 5% by mass or more, more preferably 10% by mass or more, further preferably 15% by mass or more, from the viewpoint of pore formation. The content is preferably 60% by mass or less, more preferably 50% by mass or less, further preferably 40% by mass or less, from the viewpoint of moldability.

One type of particle may be used, or two or more types of particles may be used. The inorganic particle and the organic particle may be used in combination.

When two or more types of particles are contained, the total content thereof preferably falls within the above range.

The substrate layer according to the present embodiment may further comprise, if necessary, an additive as an additional component.

Examples of the additive include heat stabilizers, antioxidants, ultraviolet stabilizers, dispersants, and lubricants. These various agents can employ conventionally known ones.

The content of the additive in the substrate layer according to the present embodiment may be, for example, 0.1 to 10% by mass. In this context, the content may be, for example, 0.1% by mass or more or may be 0.5% by mass or more and may be 10% by mass or less or may be 5% by mass or less. When two or more types of additives are contained, the total content thereof preferably falls within the above range.

The thickness of the substrate layer according to the present embodiment may be, for example, 20 to 200 μm. In this context, the thickness may be, for example, 20 μm or larger and is preferably 30 μm or larger, further preferably 40 μm or larger, from the viewpoint that wrinkling can be prevented in printing or processing by imparting moderate stiffness to the laminate, while the laminate, when inserted into a mold, is easily mounted to the desired position in in-mold molding. The thickness may be 200 μm or smaller and is preferably 150 μm or smaller, more preferably 100 μm or smaller, from the viewpoint of preventing reduction in strength of a boundary portion of the laminate to an adherend (resin container) obtained by in-mold molding.

The porosity of the substrate layer according to the present embodiment is preferably 15 to 45%. In this context, the porosity is preferably 15% or more, more preferably 25% or more, further preferably 30% or more, from the viewpoint of obtaining opacity and, when a resin container is used as an adherend, from the viewpoint of efficiently obtaining favorable adhesiveness to the adherend using the heat of a parison in producing the resin container. The porosity is preferably 45% or less, more preferably 40% or less, further preferably 38% or less, from the viewpoint of mechanical strength.

### <Adherend>

Examples of the adherend to or from which the laminate according to the present embodiment is bonded and removed preferably include, but are not particularly limited to, resin containers.

For the adherend made of a resin, examples of the raw material resin include ethylene-based resin, propylene-based resin, ester-based resin, styrene-based resin, vinyl chloride-based resin, and other resins. Among them, the raw material resin is more preferably ethylene-based resin or propylene-based resin.

### <<Method for Producing Laminate>>

The method for producing the laminate according to the present embodiment is not particularly limited as long as the laminate described in the preceding section <<Laminate>> can be obtained. The laminate can be produced, for example, by establishing the heat sealing layer on the underlayer by coating or the like. The laminate further comprising a substrate layer may be produced, for example, by laminating the underlayer and the substrate layer in this order, and establishing the heat sealing layer on the side opposite to the substrate layer side of the underlayer by coating or the like.

Specifically, for example, a method described below can be adopted. However, the production method is not limited to the following method.

A resin composition for the substrate layer is melt-kneaded in advance, extruded into a sheet form, and stretched in the machine direction through the use of the difference in circumferential velocity of a roll group to obtain a MD stretched film. Subsequently, a resin composition for the underlayer is melt-kneaded in advance and laminated in a sheet form onto the MD stretched film obtained as described above, and the resultant is stretched in the transverse direction at a specific temperature using a tenter. Then, a sheet having the substrate layer and the underlayer is obtained through heat treatment and cooling.

As for the stretching for each layer, the layers may be each individually stretched before lamination or may be stretched together after lamination. Alternatively, a non-stretched layer and a stretched layer may be laminated and then stretched again.

In the case of stretching a film, examples of the stretching method include a MD stretching method that exploits the difference in circumferential velocity of a roll group, a TD stretching method using a tenter oven, a sequential biaxial stretching method as a combination thereof, a rolling method, a simultaneous biaxial stretching method using a combination of a tenter oven and a pantograph, and a simultaneous biaxial stretching method using a combination of a tenter oven and a linear motor.

A simultaneous biaxial stretching (inflammation molding) method may be used which involves extrusion-molding a melted resin into a tube form using an annular die connected to a screw-type extruder, and then blowing air into the extrudate.

When the thermoplastic resin used is an amorphous resin, the stretching temperature at which stretching is carried out is preferably a temperature equal to or higher than the glass transition temperature of the thermoplastic resin. When the thermoplastic resin is a crystalline resin, the stretching temperature is preferably within the range from a temperature equal to or higher than the glass transition temperature of an amorphous moiety of the thermoplastic resin to a temperature equal to or lower than the melting point of a crystalline moiety of the thermoplastic resin, specifically preferably a temperature lower by 2 to 60° C. than the melting point of the thermoplastic resin.

The stretching rate is not particularly limited and is preferably 20 to 350 m/min from the viewpoint of stable stretch-molding.

The draw ratio can be appropriately determined in consideration of the characteristics and the like of the thermoplastic resin used.

For example, in the case of stretching a resin film comprising a homopolymer or a copolymer of propylene in one direction, the draw ratio is usually 1.2 or more times, preferably 2 or more times, in terms of the lower limit, and usually 12 or less times, preferably 10 or less times, in terms of the upper limit.

In the case of biaxially stretching the resin film, the draw ratio is an area draw ratio and is usually 1.5 or more times, preferably 10 or more times, in terms of the lower limit, and usually 60 or less times, preferably 50 or less times, in terms of the upper limit.

The heat sealing layer is formed on the sheet having the substrate layer and the underlayer obtained as described above. The surface on the underlayer side of the sheet is preferably subjected to oxidation treatment to activate the surface, from the viewpoint of enhancing adhesion to the heat sealing layer.

Examples of the oxidation treatment include corona discharge treatment, flame treatment, plasma treatment, glow discharge treatment, and ozone treatment.

The oxidation treatment is preferably corona discharge treatment or flame treatment, more preferably corona discharge treatment.

In the case of carrying out corona discharge treatment, the amount of discharge is, for example, 600 J/m² (10 W·min/m²) or more and 12,000 J/m² (200 W·min/m²) or less. In this context, the amount of discharge is preferably 600 J/m² (10 W·min/m²) or more, more preferably 1,200 J/m² (20 W·min/m²) or more, and preferably 12,000 J/m² (200 W·min/m²) or less, more preferably 10,800 J/m² (180 W·min/m²) or less.

In the case of carrying out flame treatment, the amount of discharge is, for example, 8,000 J/m² or more and 200,000 J/m² or less. In this context, the amount of discharge is preferably 8,000 J/m² or more, more preferably 20,000 J/m² or more, and preferably 200,000 J/m² or less, more preferably 100,000 J/m² or less.

The heat sealing layer can be established on the underlayer of the sheet by coating or the like.

Examples of the coating method include roll coating, blade coating, bar coating, air knife coating, gravure coating, reverse coating, die coating, lip coating, spray coating, comma coating, and size press coating.

### <<Label>>

The laminate according to the present embodiment is suitably used in, for example, a label.

Specifically, the label according to the present embodiment comprises the laminate and a printed layer. In this context, the laminate can employ the laminate described in the preceding section <<Laminate>>, and a preferred aspect thereof is also the same as described therein. In particular, the laminate more preferably further comprises a substrate layer.

The printed layer according to the present embodiment is a layer established by printing on the side opposite to the underlayer side of the substrate layer in the laminate. The label according to the present embodiment is thereby obtained.

Examples of the printed information in the printed layer include trade names, trade descriptions such as logo, manufacturers, distributer names, methods for use, and barcodes.

Examples of the printing method for forming the printed layer include gravure printing, offset printing, flexographic printing, seal printing, and screen printing.

<<Container with Laminate and Labeled Container>>

The container with a laminate according to the present embodiment comprises a resin container and a laminate bonded to at least a partial region of the surface of the resin container. In this context, the laminate can employ the laminate described in the preceding section <<Laminate>>, and a preferred aspect thereof is also the same as described therein. In particular, the laminate more preferably further comprises a substrate layer.

The labeled container according to the present embodiment comprises a resin container and a label bonded to at least a partial region of the surface of the resin container. In this context, the label can employ the laminate described in the preceding section <<Label>>, and a preferred aspect thereof is also the same as described therein.

In the container with a laminate and the labeled container according to the present embodiment, the laminate and the label, respectively, are bonded to the surface of the resin container.

The resin container is preferably an in-mold molded body.

Examples of the raw material resin for the resin container include ethylene-based resin, propylene-based resin, ester-based resin, styrene-based resin, vinyl chloride-based resin, and other resins. Among them, the raw material resin is preferably ethylene-based resin or propylene-based resin.

A method for producing the container with a laminate or the labeled container according to the present embodiment is not particularly limited.

In one aspect, examples of the production method include a production method which involves heating the laminate or the label so that the heat sealing layer constituting the laminate or the label is activated and attached to the resin container.

In another aspect, examples thereof include a production method which involves placing the laminate or the label of ordinary temperature on the surface of the resin container, and pressing thereagainst the laminate or the label with the heat sealing layer activated by heating to attach the laminate or the label to the resin container.

In a further alternative aspect, examples thereof preferably include a production method which involves preparing the resin container by in-mold molding, and attaching the laminate or the label with the heat sealing layer activated by the heat of the molded resin melted during this molding, to the surface of the resin container. In this case, the laminate or the label is a laminate for in-mold molding or a label for in-mold molding.

### EXAMPLES

Hereinafter, the present invention will be further specifically described with reference to Examples and Comparative Examples. Materials, amounts of use, proportions, operations, and the like shown in the examples given below can be appropriately changed or modified without departing from the spirit of the present invention. Thus, the scope of the present invention is not limited by the specific examples given below.

### <<Evaluation>>

<Melting point>

The melting point of a thermoplastic resin was measured using a differential scanning calorimeter (DSC) in accordance with JIS K 7121 (2012). When a graph obtained using DSC had one peak attributed to melting, a melting peak temperature was regarded as the melting point. When the graph had a plurality of peaks, a point at which an integrated value of peak areas from the lower-temperature side of the plurality of peaks became 50% of the total peak area was regarded as the melting point.

### <Thickness>

The thickness of the whole laminate was measured using a constant-pressure thickness gauge (manufactured by TECLOCK Co., Ltd., trade name: PG-01J) in accordance with JIS K 7130 (1999).

The thickness of each layer constituting the laminate was measured by the following method.

The laminate was cooled to a temperature of −60° C. or lower with liquid nitrogen, placed on a glass plate, and then cut with a razor blade (manufactured by Schick Japan K.K., trade name: Proline Blade) put thereon at a right angle to prepare a sample for cross-sectional observation. The obtained sample was cross-sectionally observed under a scanning electron microscope (manufactured by JEOL Ltd., trade name: JSM-6490), and the interlayer boundaries of a heat sealing layer, an underlayer, and a substrate layer were identified from composition and appearance. Then, the thickness ratio of each layer was determined, and the thickness of the whole laminate described above was multiplied by the obtained thickness ratio to determine the thickness of each layer.

### <Porosity>

The porosities of the underlayer and the substrate layer constituting the laminate were calculated according to the following expression (1).

$$Porosity ( \% ) = \{ ( {ρ}_{0} - ρ ) / {ρ}_{0} \} \times 100 \qquad ( 1 )$$

wherein ρ₀ represents a true density, and ρ represents a density.

### <Adhesiveness>

The adhesiveness of the laminate was evaluated by the following method.

The obtained laminate was cut into a sheet form and punched into a rectangle having a long side of 8 cm and a short side of 6 cm. The punched laminate was placed in one of the molds for blow molding capable of forming a resin container having an internal capacity of 0.4 L such that the heat sealing layer faced the cavity side. The laminate was mounted to the mold through the use of aspiration.

High-density polyethylene (trade name: NOVATEC HD HB420R, manufactured by Japan Polyethylene Corp., MFR (JIS K 7210 (1999)): 0.2 g/10 min, density (JIS K 7112 (1999)): 0.956 g/cm³) was melted at 180° C. between the molds and extruded into a parison form. The parison at a portion to which the laminate would be affixed was set to 180° C.

After clamping of the molds, compressed air of 4.2 kg/cm² was supplied into the parison, and the parison was swollen for 20 seconds and tightly contacted with the molds so that the parison was prepared into a container shape while fused to the laminate. Subsequently, the molded product was cooled in the molds, which were then opened to obtain a container with the laminate.

The container with the laminate obtained as described above was stored for 2 days in an environment having a temperature of 23° C. and a relative humidity of 50%. Next, the laminate and the container body in a region where the laminate was disposed in the container with the laminate were integrally cut out with a cutter. Three samples for measurements having a length of 12 cm (laminate-affixed portion: 8 cm, non-affixed portion: 4 cm) and a width of 1.5 cm (the laminate was affixed throughout the width) were collected when the circumferential direction of the barrel of the container was defined as the longitudinal direction. The same procedures as above were performed as to two containers with the laminate to collect a total of six samples for measurements.

Next, the laminate-affixed portion was carefully peeled from the non-affixed portion by manual operation and peeled by approximately 1 cm to form a grip. A PET film (thickness: 50 μm) having a width of 1.5 cm was put on this grip and bonded thereto with a pressure-sensitive adhesive to prepare a grip portion on the laminate side. The resultant was used as a sample for adhesive strength measurement.

The sample for adhesive strength measurement obtained as described above was subjected to a 180-degree peeling test on the barrel portion of the resin container and the laminate under conditions involving a peeling rate of 300 mm/min using a tensile tester (manufactured by Shimadzu Corp., model name: Autograph AGS-5kNJ) on the basis of JIS K 6854-2 (1999).

The peel force at a peeling length from 25 to 75 mm was measured as to the laminate, and an average value thereof was regarded as the peel force of the sample. This measurement was performed using the six samples for measurements for each laminate, and an average value of the peel forces from the six samples was regarded as the adhesive strength.

The results are shown in the column “Adhesive strength (gf/15 mm)” of Table 2. A value equal to or more than 150 gf/15 mm was determined as acceptable as adhesive strength without practical problems.

### <Removability>

The removability of the laminate was evaluated by the following method.

A container with the laminate was obtained in the same manner as the method described in the preceding section <Adhesiveness>.

A portion to which the laminate was attached in the container with the laminate was cut out. The mass (Ta) of the cut-out container with the laminate was measured. This portion to which the laminate was bonded was granulated into flakes using a crusher (manufactured by Morita Seiki K.K., product name: XL-15, mesh screen size: 8 mmϕ) to prepare a sample for evaluation. Then, the total mass (Tb) of the resin container and the laminate remaining on the resin container (not removed from the resin container in the granulation step) was measured. Then, the laminate was completely removed from the resin container, and the mass (B) of the remaining resin container was measured.

The removing rate (%) of the laminate was determined according to the following expression using these masses Ta, Tb, and B measured as described above.

$$Removing rate ( \% ) of the laminate ( \% ) = ( Ta - Tb ) / ( Ta - B ) \times 100$$

The results are shown in the column “Removability” of Table 2, and the evaluation criteria are as described below.
A: Very favorable with a removing rate of 95% or more
B: Practical with a removing rate of 70% or more and less than 95%
C: Poor with a removing rate of less than 70%

### <Heat Sealing Layer Residue>

The heat sealing layer residues of the laminate were evaluated by the following method.

The surface of the sample after adhesive strength measurement (resin container after removing of the laminate) obtained in the preceding section <Adhesiveness> was observed at 20 positions under a scanning electron microscope (manufactured by JEOL Ltd., trade name: JSM-6490) to confirm the presence or absence of the heat sealing layer.

The results are shown in the column “Residual heat sealing layer” of Table 2, and the evaluation criteria are as described below.
A: Very favorable as the heat sealing layer rarely remained in the observation field
B: Favorable as the heat sealing layer remained, albeit slightly, in the observation field
C: Poor as the heat sealing layer remained in more than half the area of the observation field

### Example 1

### <Substrate Layer>

70% by mass of a propylene homopolymer (trade name: NOVATEC PP FY4, manufactured by Japan Polypropylene Corp., MFR (230° C., 2.16 kg load): 5 g/10 min, melting point: 167° C.), 10% by mass of high-density polyethylene (trade name: NOVATEC HD HJ360, manufactured by Japan Polyethylene Corp., MFR (190° C., 2.16 kg load): 5 g/10 min, melting point: 131° C.), and 20% by mass of a heavy calcium carbonate fine powder (manufactured by Bihoku Funka Kogyo Co., Ltd., product name: SOFTON #1800, volume-average particle size: 1.8 μm) were mixed, and this mixture was supplied to an extrusion die set to 230° C., and extruded into a sheet form. This extrudate was cooled to 60° C. using a cooling apparatus to obtain a non-stretched sheet.

The obtained non-stretched sheet was heated to 140° C. and stretched at a draw ratio of 5 times in the machine direction through the use of the difference in circumferential velocity of a roll group to obtain a substrate layer which was a stretched layer.

### <Underlayer>

30% by mass of an ethylene-propylene random copolymer (trade name: WINTEC WFW4, manufactured by Japan Polypropylene Corp., MFR (230° C., 2.16 kg load): 7 g/10 min, melting point: 143° C.), 25% by mass of a propylene homopolymer (trade name: NOVATEC PP MA3, manufactured by Japan Polypropylene Corp., MFR (230° C., 2.16 kg load): 11 g/10 min, melting point: 167° C.), and 45% by mass of a heavy calcium carbonate fine powder (trade name: SOFTON #1800, manufactured by Bihoku Funka Kogyo Co., Ltd., volume-average particle size: 1.8 μm) were mixed, and this mixture was melted in an extruder heated to 210° C., and then extruded into a sheet form so as to come into contact with the substrate layer obtained as described above so that the extrudate was laminated on one of the surfaces of the substrate layer to obtain a two-layer laminated sheet.

Subsequently, the obtained two-layer laminated sheet was cooled to 60° C., then heated to approximately 150° C. using a tenter oven, stretched at a draw ratio of 9 times in the transverse direction, and then further heated to 160° C. for heat treatment.

Then, the sheet was cooled to 60° C. and slitted for a selvage to obtain a laminated resin film consisting of the substrate layer and the underlayer and having a total thickness of 83 μm (underlayer/substrate layer=3 μm/80 μm) and the number of stretching axes for each layer of underlayer/substrate layer=monoaxial/biaxial.

### <Heat Sealing Layer>

The surface on the underlayer side of the laminated resin film obtained as described above was treated by corona discharge. Subsequently, the treated surface was coated with a coating composition using a bar coater such that a solid content per unit area after drying was 0.15 g/m².

The coating composition was a mixture of an ethylene-methacrylic acid copolymer (EMAA) dispersion (trade name: AC-3100, manufactured by Japan Coating Resin Co., Ltd., melting point: 90° C., average particle size: 1.0 μm) and polyethyleneimine (trade name: SAFTOMER AC72, manufactured by Mitsubishi Chemical Corp., solid concentration: 32% by mass), and the amounts of these components mixed were adjusted such that the resulting heat sealing layer had an ethylene-methacrylic acid copolymer content of 94% by mass and a polyethyleneimine content of 6% by mass.

Subsequently, the coating film was dried in an oven of 60° C. so that a heat sealing layer was formed to obtain a laminate having the substrate layer, the underlayer, and the heat sealing layer in this order.

The detailed components constituting the substrate layer, the underlayer, and the heat sealing layer are summarized in Table 1.

TABLE 1

| | Type | Material |
|---|---|---|
| Heat | Thermoplastic | Ethylene-methacrylic acid copolymer (EMAA) dispersion (trade |
| sealing | resin (A) | name: AC-3100, manufactured by Japan Coating Resin Co., |
| layer | | Ltd., melting point: 90° C., average particle size: 1.0 μm) |
| | Polyethyleneimine | Polyethyleneimine (trade name: SAFTOMER AC72, |
| | | manufactured by Mitsubishi Chemical Corp., solid |
| | | concentration: 32% by mass) |
| Underlayer | Thermoplastic | Ethylene-propylene random copolymer (trade name: WINTEC |
| | resin (B) | WFW4, manufactured by Japan Polypropylene Corp., MFR |
| | | (230° C., 2.16 kg load): 7 g/10 min, melting point: 143° C.) |
| | Thermoplastic | Propylene homopolymer (trade name: NOVATEC PP MA3, |
| | resin (C) | manufactured by Japan Polypropylene Corp., MFR (230° C., |
| | | 2.16 kg load): 11 g/10 min, melting point: 167° C.) |
| | Particle | Heavy calcium carbonate fine powder (trade name: SOFTON |
| | | #1800, manufactured by Bihoku Funka Kogyo Co., Ltd., |
| | | volume-average particle size: 1.8 μm) |
| Substrate | Thermoplastic | Propylene homopolymer (trade name: NOVATEC PP FY4, |
| layer | resin | manufactured by Japan Polypropylene Corp., MFR (230° C., |
| | | 2.16 kg load): 5 g/10 min, melting point: 167° C.) |
| | | High-density polyethylene (trade name: NOVATEC HD HJ360, |
| | | manufactured by Japan Polyethylene Corp., MFR (190° C., 2.16 |
| | | kg load): 5 g/10 min, melting point: 131° C.) |
| | Particle | Heavy calcium carbonate fine powder (trade name: SOFTON |
| | | #1800, manufactured by Bihoku Funka Kogyo Co., Ltd., |
| | | volume-average particle size: 1.8 μm) |

### Example 2

A laminate having the substrate layer, the underlayer, and the heat sealing layer in this order was obtained in the same manner as in Example 1 except that in the process of producing the substrate layer, the heating temperature of the non-stretched sheet was changed from 140° C. to 155° C., and the sheet was stretched in the machine direction; and in the process of producing the underlayer, the heating temperature of the two-layer laminated sheet was changed from approximately 150° C. to approximately 170° C., and the sheet was stretched in the transverse direction.

### Example 3, Example 4, Example 6 to Example 8, and Comparative Example 1 to Comparative Example 3

A laminate having the substrate layer, the underlayer, and the heat sealing layer in this order was obtained in the same manner as in Example 1 except that the mixing ratio of the ethylene-propylene random copolymer (trade name: WINTEC WFW4, manufactured by Japan Polypropylene Corp., MFR (230° C., 2.16 kg load): 7 g/10 min, melting point: 143° C.), the propylene homopolymer (trade name: NOVATEC PP MA3, manufactured by Japan Polypropylene Corp., MFR (230° C., 2.16 kg load): 11 g/10 min, melting point: 167° C.), and the heavy calcium carbonate fine powder (trade name: SOFTON #1800, manufactured by Bihoku Funka Kogyo Co., Ltd., volume-average particle size: 1.8 μm) for the underlayer was changed to each ratio described in Table 2.

### Example 5 and Comparative Example 4

A laminate having the substrate layer, the underlayer, and the heat sealing layer in this order was obtained in the same manner as in Example 1 except that the amount of coating with the coating composition for forming the heat sealing layer was changed such that the solid content per unit area after drying was each amount described in Table 2.

TABLE 2

| | | Example | Example | Comparative | Example | Comparative | Example |
|---|---|---|---|---|---|---|---|
| | | 1 | 2 | Example 1 | 3 | Example 2 | 4 |
| Heat | Thermoplastic resin | 94 | 94 | 94 | 94 | 94 | 94 |
| sealing | (A) (% by mass) | | | | | | |
| layer | Polyethyleneimine | 6 | 6 | 6 | 6 | 6 | 6 |
| | (% by mass) | | | | | | |
| | Solid content per | 0.15 | 0.15 | 0.15 | 0.15 | 0.15 | 0.15 |
| | unit area (g/m²) | | | | | | |
| Underlayer | Thermoplastic resin | 30 | 30 | 15 | 45 | 55 | 30 |
| | (B) (% by mass) | | | | | | |
| | Thermoplastic resin | 25 | 25 | 40 | 10 | — | 70 |
| | (C) (% by mass) | | | | | | |
| | Particle (% by | 45 | 45 | 45 | 45 | 45 | — |
| | mass) | | | | | | |
| | Thickness (μm) | 3 | 3 | 3 | 3 | 3 | 3 |
| | Porosity (%) | 10 | 0 | 14 | 6 | 0 | 0 |
| Substrate | Propylene | 70 | 70 | 70 | 70 | 70 | 70 |
| layer | homopolymer (% by | | | | | | |
| | mass) | | | | | | |
| | High-density | 10 | 10 | 10 | 10 | 10 | 10 |
| | polyethylene (% by | | | | | | |
| | mass) | | | | | | |
| | Particle (% by | 20 | 20 | 20 | 20 | 20 | 20 |
| | mass) | | | | | | |
| | Porosity (%) | 35 | 20 | 35 | 35 | 35 | 35 |
| Evaluation | Adhesive strength | 280 | 200 | 140 | 350 | 500 or more | 250 |
| | (gf/15 mm) | | | | | | |
| | Removability | A | A | A | B | C | A |
| | Residual heat | A | A | B | A | A | A |
| | sealing layer | | | | | | |

| | | Comparative | Example | Comparative | Example | Example | Example |
|---|---|---|---|---|---|---|---|
| | | Example 3 | 5 | Example 4 | 6 | 7 | 8 |
| Heat | Thermoplastic resin | 94 | 94 | 94 | 94 | 94 | 94 |
| sealing | (A) (% by mass) | | | | | | |
| layer | Polyethyleneimine | 6 | 6 | 6 | 6 | 6 | 6 |
| | (% by mass) | | | | | | |
| | Solid content per | 0.15 | 1 | 3 | 0.15 | 0.15 | 0.15 |
| | unit area (g/m²) | | | | | | |
| Underlayer | Thermoplastic resin | — | 30 | 30 | 20 | 40 | 20 |
| | (B) (% by mass) | | | | | | |
| | Thermoplastic resin | 55 | 25 | 25 | 10 | — | 20 |
| | (C) (% by mass) | | | | | | |
| | Particle (% by | 45 | 45 | 45 | 70 | 60 | 60 |
| | mass) | | | | | | |
| | Thickness (μm) | 3 | 3 | 3 | 3 | 3 | 3 |
| | Porosity (%) | 21 | 10 | 10 | 6 | 0 | 12 |
| Substrate | Propylene | 70 | 70 | 70 | 70 | 70 | 70 |
| layer | homopolymer (% | | | | | | |
| | by mass) | | | | | | |
| | High-density | 10 | 10 | 10 | 10 | 10 | 10 |
| | polyethylene (% by | | | | | | |
| | mass) | | | | | | |
| | Particle (% by | 20 | 20 | 20 | 20 | 20 | 20 |
| | mass) | | | | | | |
| | Porosity (%) | 35 | 35 | 35 | 35 | 35 | 35 |
| Evaluation | Adhesive strength | 80 | 450 | 500 or more | 160 | 300 | 160 |
| | (gf/15 mm) | | | | | | |
| | Removability | — | B | C | A | A | A |
| | Residual heat | — | B | C | B | A | B |
| | sealing layer | | | | | | |

As seen from the results of Example 1, the heat sealing layer was melted at the time of in-mold molding in preparing a resin container with the laminate, and the thermoplastic resin (B) contained in the underlayer was also melted or softened so that the adhesion between the heat sealing layer and the underlayer was strengthened. As a result, high adhesive strength and favorable removability were able to be achieved. This is presumably because the softened thermoplastic resin (B) facilitated the heat sealing layer to follow the shape of the adherend and elevated a contact area therebetween.

In Example 2 compared with Example 1, the resin was more melted at the time of stretching. Therefore, pores originating from the particle were less likely to occur, presumably reducing a porosity. Since a heat insulating effect brought about by the porosity was reduced, the quantity of heat of the parison could not be efficiently exploited for bonding. Thus, adhesive strength was slightly reduced as compared with Example 1, and however, favorable results were obtained.

In Comparative Example 1, adhesive strength was reduced due to large contents of the thermoplastic resin (C) and the particle. Furthermore, a small content ratio of the thermoplastic resin (B) weakened the adhesion between the heat sealing layer and the underlayer. It was consequently considered that the heat sealing layer partially remained on the adherend.

As seen from the results of Example 3, high adhesive strength was achieved owing to a large content of the thermoplastic resin (B), whereas a portion of the laminate was not removed from the resin container in the granulation of the resin container.

As seen from the results of Comparative Example 2, the thermoplastic resin (B) of the underlayer also contributed to adhesiveness to the adherend, though the heat sealing layer was thin. As a result, adhesive strength was large, and the laminate was rarely removed from the resin container at the time of granulation of the resin container.

As seen from the results of Example 4, adhesive strength and removability equivalent to those of Example 1 were able to be achieved, even if the underlayer in the laminate contained no particle.

As seen from the results of Comparative Example 3, the adhesive strength was very small because the heat sealing layer was thin and furthermore, the underlayer contained no thermoplastic resin (B). Hence, removability was not evaluated and was therefore indicated by “−” in Table 2.

In Example 5, adhesive strength was enhanced by increasing the solid content per unit area of the heat sealing layer. On the other hand, as seen from the results, a portion of the laminate was not removed at the time of granulation of the resin container, and cohesive failure of the heat sealing layer occurred, thereby causing the heat sealing layer to remain partially on the removed surface of the resin container.

In Comparative Example 4, the solid content per unit area of the heat sealing layer was further increased with respect to Example 5. As a result, the laminate was not removed at the time of granulation of the resin container. Furthermore, the heat sealing layer remained markedly on the removed surface of the resin container.

In Example 6 compared with Example 4, adhesive strength was able to be achieved without practical problems, though adhesive strength was reduced. As seen from the results, the content of the thermoplastic resin (B) in the underlayer was small, and a portion of the laminate was not removed at the time of granulation of the resin container.

The results of Example 7 and Example 8 exhibited a tendency similar to that of Example 4 and Example 6.

The present invention is described above in detail and with reference to specific embodiments. However, it is obvious to those skilled in the art that various changes or modification can be made in the present invention without departing from the spirit and scope of the present invention.

The invention claimed is:

1. A laminate comprising a heat sealing layer and an underlayer, wherein
a solid content per unit area of the heat sealing layer is 0.05 to 1.5 g/m²,
the heat sealing layer comprises a thermoplastic resin (A) having a melting point of Tm(A),
the underlayer comprises a thermoplastic resin (B),
the thermoplastic resin (B) has a melting point Tm(B) of (Tm(A)+10° C.) or higher and lower than (Tm(A)+60° C.),
a content of a thermoplastic resin having a melting point of lower than (Tm(A)+10° C.) in the underlayer is 20% by mass or less, and
a content of the thermoplastic resin (B) in the underlayer is 20 to 50% by mass.

2. The laminate according to claim 1, wherein
the underlayer further comprises a thermoplastic resin (C), and
the thermoplastic resin (C) has a melting point Tm(C) of (Tm(A)+60° C.) or higher.

3. The laminate according to claim 1, wherein the underlayer further comprises a particle.

4. The laminate according to claim 1, wherein a thickness of the underlayer is 0.5 to 10 μm.

5. The laminate according to claim 1, wherein a content of the thermoplastic resin (A) in the heat sealing layer is 50% by mass or more.

6. The laminate according to claim 1, wherein a content of the thermoplastic resin (B) in the underlayer is 20 to 50% by mass.

7. The laminate according to claim 2, wherein a content of the thermoplastic resin (C) in the underlayer is 5 to 80% by mass.

8. The laminate according to claim 3, wherein a content of the particle in the underlayer is 5 to 70% by mass.

9. The laminate according to claim 3, wherein the underlayer is a stretched layer and contain a pore.

10. The laminate according to claim 1, wherein a porosity of the underlayer is 3 to 30%.
